(19) United States
(12) Patent Application Publication
(10) Pub. No.: US 2006/0177940 A1
(43) Pub. Date: Aug. 10, 2006

(54) Optical trap separations in microfluidic flows

(76) Inventor: Eric M. Furst, Philadelphia, PA (US)

Correspondence Address: McCarter & English, LLP;Citizens Bank Center, Suite 1800, 919 N. Market Street, Wilmington, DE, 19801-3033, US

(21) Appl. No.: 11/152,316

(22) Filed: Jun. 14, 2005

Related U.S. Application Data
(63) Continuation-in-part of application No. 11/052,305, filed on Feb. 7, 2005, now abandoned.

(51) Int. Cl. G01N 1/00

(52) U.S. Cl. 436/177

(57) ABSTRACT

The present invention is directed to a method for separating and analyzing particles in a microfluidic flow. The method comprises the step of providing a microfluidic channel having an array of static optical traps disposed therein. A flow of solution is then provided through the channel, wherein the solution contains one or more particles. The particles are separated, diverted or retained by the static optical traps that are positioned in a predetermined array, and, if desired, focused in a path for analytical purposes.

### CROSS REFERENCE TO RELATED APPLICATION

This application is a Continuation-in-Part of application Ser. No. 11/052,305, filed Feb. 7, 2005, now abandoned.

### FIELD OF THE INVENTION

The invention is in the field of optical separations in microfluidic flows. Specifically, the invention is in the field of separating, sorting and manipulating particles and cells in microfluidic flows.

### BACKGROUND OF THE INVENTION

MicroTAS and Microfluidics

Chemical and bio-analytical systems are undergoing a revolution in miniaturization. Similar to the transition from electronics to microelectronics that gave rise to increasingly powerful microprocessors and computational tools, the development of micro total analytical systems (microTAS) stands to advance biological, chemical, and medical analysis by providing rapid, high-throughput and integrated chemical operations, like sample preparation and isolation, reactions, separations and various other steps, such as heating, cooling and mixing, all on a micro scale. Scientists and engineers envision mictoTAS technologies that will accept minimally processed samples from the environment (i.e. whole blood, automated air and water samples) and perform the necessary steps to arrive at an analysis (detection of a pathogen, DNA sequences to detect disease, the presence of a protein, etc.). A prototype device that illustrates one such implementation of a microTAS technology has been reported in the literature (Mark A. Burns, et al. Science, 282:484-487, 1998). The device accepts DNA solutions and performs the necessary chemical, heating and separations to sequence the DNA. Although far from an established commercial technology, the work demonstrates the feasibility and power of microTAS technologies. In the future, simple handheld devices based on these concepts will reduce the costly overhead of specialists and laboratories for routine analysis, benefiting medical diagnostics, forensics and agricultural testing. Such devices will also minimize analyte quantities and maximize the number of assays that can be carried out in parallel. Because of their small footprint, microTAS devices may be seamlessly integrated into processing and communication platforms, and largely transparent, both functionally and physically, when incorporated into other systems.

The chemical unit operations in a microTAS device are performed in networks of small channels, with dimensions typically on the order of 10-100 micrometers. Hence, they are commonly referred to as microfluidic systems.

Microfluidic Separations

Separations are one of the critical unit operations in chemical systems. In an analytical process, separations usually occur both upstream and downstream of other operations, such as reactions. On the upstream side, sufficient separations must usually be performed to isolate the material of interest, i.e. white blood cells from platelets and erythrocytes in whole blood, DNA and proteins from other cell lysate products, etc. Downstream, separations are also a common method of analysis, such as the separation of DNA restriction enzyme fragments or the gel electrophoresis of DNA PCR products.

Advances in microfluidic separations and analyte control will benefit many areas such as clinical care, medical research, pharmaceutical development, and environmental monitoring. For instance, applications include devices that enable rapid, point-of-care analysis, rapid genome sequencing, fast pharmaceutical screening, chemical and biological weapons detection, and chemical and environmental monitoring.

In order to achieve the improved functionality available with miniaturization of separations, reactions and analytical operations, these operations must be easily incorporated into rugged, integrated architecture. One drawback of the current practice is that the devises are typically coupled to large laboratory equipment, such as microscopes, lasers and syringe pumps. Currently, only a handful of completely integrated chemical systems have been demonstrated. The limited success of developing these systems in miniature architectures reflects the difficult challenges faced in miniaturizing complex microscale components, such as gears cantilevers, and pumps. These types of components have yet to be successfully incorporated into functioning microfluidic systems.

In an effort to avoid the fabrication difficulties associated with miniaturizing traditional separation and analytical components, devices have been engineered to exploit inherent physical properties of microfluidic flow dynamics. Currently, these devices are focused on downstream microfluidic separation of DNA restriction fragments and proteins, and cells and large macromolecules.

Optical Traps

To generate an optical trap, a single laser beam is focused to a diffraction limited spot. In the ray-optic regime (particle diameter much greater than the optical wavelength, d>>λ), as a photon passes through the particle, its change in momentum imparts a reactive force against the particle. The equilibrium particle position is offset from the beam focus in the direction of propagation due to scattering and absorption. In the Rayleigh regime (particle diameter is much less than the optical wavelength, d<<λ), the dielectric particle minimizes the energy density stored in the electric field when it occupies the center of the focus. Thus, the particle experiences a Lorentzian force from the time-averaged electric field intensity pulling it into the light gradient. When the size of the particle is on the order of the wavelength, resonant modes between scattering volumes complicate the quantitative description.

There remains, however, a need for a simpler, highly selective method to separate particles, including cells, at the microfluidic level.

### SUMMARY OF THE INVENTION

The present invention includes a method of separating particles and cells from a microfluidic flow. The method comprises the step of providing a microfluidic channel containing a solution flowing therein. The solution contains a plurality of particles with at least one particle having an index of refraction different from the index of refraction of the solution. The method also includes forming an optical trap located within the channel, and forming an interaction between the at least one particle and the optical trap.

In an alternate embodiment, the method of the invention includes attaching a label unit to at least one particle, wherein the label unit has a higher index of refraction than the at least one particle. In yet another embodiment, the method comprises the step of mixing a first particle and a second particle in the solution, and forming an interaction between the optical trap and a composite particle formed from binding the first particle to the second particle.

Also included in the invention is an apparatus for separating particles. The apparatus comprises a mircofluidic channel and an array of stationary optical traps positioned within the channel. The channel contains a solution of particles, and the solution flows through the channel. In an alternate embodiment, the array of optical traps is a two-dimensional ordered array. Alternatively, the array of optical traps is a two-dimensional cone-shaped focusing array.

### BRIEF DESCRIPTION OF THE DRAWINGS

FIG. 1(A) Schematic displaying example of an arrays of optical traps wherein larger particles are slowed or held by the traps (x), while smaller particles continue uninhibited, resulting in different retention times in the microfluidic channel.

FIG. 1(B) Schematic displaying example of an arrays of optical traps wherein this focusing array “lines-up” the particles along the center of the array as the individual particles are transported from trap (x) to trap in the flow.

FIG. 1(C) Schematic displaying example of an arrays of optical traps wherein lines of closely-spaced optical traps (x), or “optical channels”, can be used to selectively divert particles based on size. The separation is governed by the residence time particles spend in each trap (x) before moving to the next downstream trap.

FIG. 2(A) Graph of Force (F) vs. Distance (r/a) calculated for a linear array of optical traps forming an “optical channel” showing particles driven into neighboring downstream traps by diffusing over the potential barrier. This results in a hopping-like motion of the particle from trap to trap. This mode of transport may benefit from collisions, which will generate long, but finite, residence times for the particles. The residence time of the particle in each trap governs the retention time of the separation.

FIG. 2(B) Graph of Force (F) vs. Distance (r/a) calculated for a linear array of optical traps forming an “optical channel” plotting the forces in an array with traps more closely spaced than in A. The closer spacing of the traps causes the particles to continuously move along the array until reaching the last trap.

FIG. 3: Schematic demonstrating optical focusing along the trap axes. Optical traps are used to direct particles or cells into the center of a channel, for example, by the gradient force or a combination of gradient and scattering and absorption forces.

FIG. 4(A) Schematic of a time-modulated optical array wherein small particles are separated from large particles by the traps by retaining the large particles in the optical trap array, while the solution flow removes the smaller particles into the channel on the right.

FIG. 4(B) Schematic of a time-modulated optical array wherein the large particles are separated from the small particles, and retained in the optical trap array.

FIG. 4(C) Schematic of a time-modulated optical array wherein the optical traps are turned off, solution flow is directed from the top towards the bottom, and the large particles are directed into the channel below the intersection.

FIG. 5 Sequential video frames (1-4) of time-shared optical traps manipulating three particles in a microfluidic flow. The sequence of video frames shows three particles (a, b, c) held stationary in the flow, which is moving from left to right at 140 μm/s. A fourth particle (d), slightly out of the focal plane, moves along a fluid streamline until it is captured by a trap. The scale bar is 10 μm.

FIG. 6(A) Photograph of two-dimensional hexagonal array showing a 5×5 hexagonal array filled with 3 μm polystyrene particles at a volume fraction of about 3% (laser power is about 2.5 Watts and the flow rate is about 0.02 mL/hr);

FIG. 6(B) Photograph of two-dimensional hexagonal array showing a 7×8 hexagonal array filled with 3 μm polystyrene particles at a volume fraction of about 3% (laser power is about 2.5 Watts and the flow rate is about 0.01 mL/hr).

FIG. 7(A) Top view schematic of a microfludic system of the present invention.

FIG. 7(B) lateral view through axis x-x of the microfluidic device shown in FIG. 7(A).

FIG. 8: Photograph of a 6×6 hexagonal array filled with both 1 μm and 3 μm polystyrene particles.

### DETAILED DESCRIPTION OF THE INVENTION

The invention provides a method for separating, differentiating, manipulating and diverting nanometer and micrometer-sized particles, cells and sub-cellular components and materials in microfluidic channels. For purposes of this document, any use of the term “particles” shall be inclusive of any particle capable of being separated according to the invention, including all of the just mentioned particles. The present invention provides arrays and arrangements of optical traps that perform particle manipulations. In addition, to the methods to control analytes, particles and cells the invention provides methods highly-selective to particle size and optical properties, such as refractive index contrast. The invention addresses the critical need for manipulation and separation strategies in microfluidic devices, such as micro total analytical (microTAS) or lab-on-a-chip systems. The invention is suitable for application in biological diagnostics, clinical care analysis, chemical and biological detection assays, and environmental monitoring.

In contrast to proposed microfluidic and micromechanical systems based on miniaturizations of macroscale devices, the present invention harnesses the fundamental physical properties of microscale systems, such as laminar flow, negligible inertia, and a dramatically increased effect of radiation pressure. “Optical channels” in microfluidic flows are created from linear arrangements of closely-spaced optical traps that shuttle and divert particles, adding a new element of control and manipulation.

Static Trap Arrays

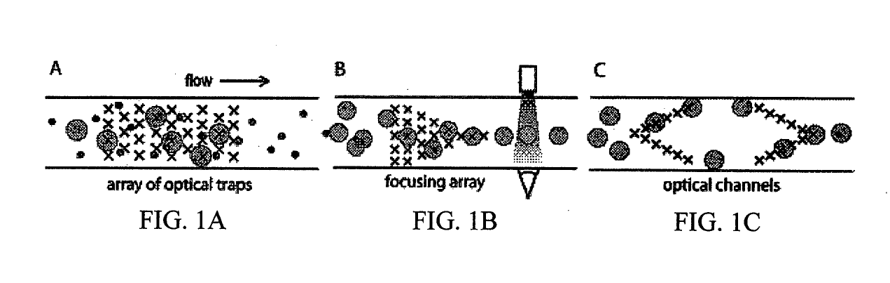

The invention provides methods and devices for conducting particle separations using one or more static arrays of optical traps. The stationary optical traps selectively retard or capture particles based on size, shape or optical properties. Using one or more arrays of optical traps, particles in microfluidic channels can be separated as illustrated, for example, in FIGS. 1A, 1B, and 1C. Arrays of optical traps, indicated by the crosses in the figures, separate particles based on size in microfluidic channels. For example, in FIG. 1A, larger particles are slowed or held by the traps, while smaller particles continue uninhibited, resulting in different retention times in the microfluidic channel. In FIG. 1B, on the other hand, a static triangular pattern of optical traps “focus” particles to the center of a channel. Such a focusing operation aids in the analysis and separation of cells, similar to conventional cytometry. In FIG. 1C, lines of closely-spaced optical traps, or “optical channels”, are used to selectively divert particles based on size.

The trap patterns and spacings can be varied and optimized in any desired fashion to accomplish effective separations. An ordered array of traps is positioned in the optimum spacing (d_{T}) for a particular separation strategy. For example, in order to selectively capture large particle aggregates formed in an agglutination assay, the trap spacings would be large enough to allow small particles to move past, and avoid collision-induced release of the aggregates from the optical traps.

Similarly, for arrays designed to slow the passage of particles based on size, the trap spacing again affects the collision-induced release of particles from traps. Both passage through the array of traps and collision-induced release are dependent on particle size. Therefore, the trap array geometry can be optimized for separation selectivity based on size.

Static arrays are also useful in directing materials in conjunction with flow, such as “focusing” the particles into the center of a channel, as illustrated, for example, in FIG. 1B. The focusing array shown in FIG. 1B serves to “line-up” the particles along the center of the array as the individual particles “hop” from trap to trap in the flow. As the array of traps narrows, so does the path of the particle. Lining up particles or cells using a focusing array allows specific particles or cells to be selected or analyzed. As illustrated in FIG 1B, a spectrometer, fluorimeter, photometer, microscope or other analysis device may be used to analyze the individual particle or cell in the flow for characteristics such as the presence of fluorescence, the fluorescence intensity, or spectral characteristics.

The focusing array of the invention allows control of particle positions independent of the microfluidic flow. Microfluidic flow in the laminar regime (i.e., low Reynolds numbers) is highly dependent on changes in the channel geometry. The focusing array of the invention provides means for controlling particle positions through changes in channel geometry. For instance, without a focusing array, lines of individual cells in narrow channels immediately broaden when the flow enters a large chamber. This creates a problem which necessitates the use of “N-port” injectors in microfluidic devices. In contrast, a focusing array at a channel inlet directs cells and confines them to narrow bands. Similarly, by making the trap spacing comparable to or smaller than the particle size, the “optical channels” selectively route the particles through the microfluidic device.

It is worth noting that while it is preferred that there be a space between the optical traps of the invention, there may be situations wherein the traps may touch each other or overlap. Generally, it is preferred that there be a space as optical traps will tend to interfere with a particle in a nearby trap if they are too close together. It may be useful, however, in some arrays to provide a plurality of traps that overlap in order to, for example, divert or trap a large number of particles or to assure trap efficiency in a rapid or pressure-driven flow, where one trap alone may not suffice.

Exploiting the inherent properties of microfluidic flows also provides novel separation techniques, because particles of specific size can be diverted in a flow. For example, large particles may be diverted to channel walls in a pressure-driven flow, as shown in FIG. 1C. When diverted to the channel walls, the larger particles experience a slower progression through the channel due to higher drag forces and slower fluid velocities near the channel wall-solution interface, while smaller particles are not diverted by the trap array, and pass through uninhibited. Alternatively, optical channels allow for selectively diverting particles across fluid interfaces, such as at low Reynolds numbers, where mixing occurs by diffusion only. This enables continuous separations, instead of chromatographic-like batch operations. Additionally, channels allow for capturing “rolling” cells, such as leukocytes, and diverting them to the center of the flow. Finally, in an alternate embodiment, the optical traps can be placed or positioned randomly within the microfluidic channel depending upon the desired separation or analysis.

To generate an optical trap, an inverted microscope, diode laser and optics are traditionally required, although various options may be used to generate arrays and arrangements of optical traps in microfluidic channels. Because separation devices are preferably compact, integrated lenses and compact diode lasers may be selected to generate the optical traps. One feasible option includes using nanofabricated diffractive microlens arrays. The microlens arrays enable compact geometries suitable for many applications, including hand-held chemical or biological diagnostic devices.

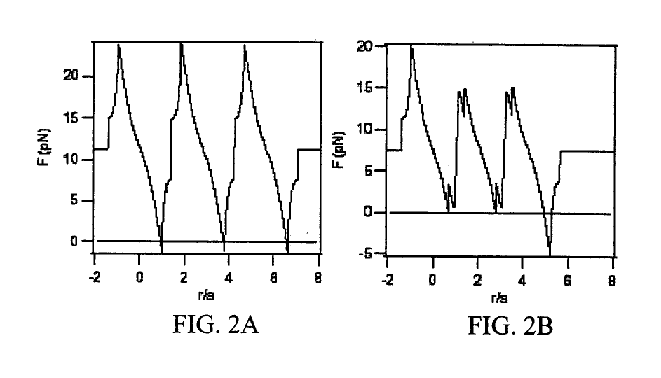

The design of an “optical channel” is based on experimentally-measured trap profiles and escape forces. Calculations for a linear array of traps, or “optical channel,” are shown in FIG. 2. These calculations were estimated using a trap force profile on 1 μm particles, laser intensity 50 mW, and Stokes drag. The graphs plot a normalized distance (r/a) against force (pN). A positive force value indicates a force pushing the particle in the direction of flow (to the right). Fluid drag offsets the trap force, biasing the total force to positive values.

FIG. 2A shows particles driven into neighboring traps by diffusing over the potential barrier, causing a motion that may benefit from collisions. The trap spacing is approximately one trap size apart, creating a series of closely-spaced potential wells. This will allow particles to “hop” from trap to trap, perhaps displaced by collisions from particles captured by upstream traps. Particle behavior in the closely-spaced traps is similar to arrays.

FIG. 2B plots the forces in an array with traps more closely spaced than in FIG. 2A. The closer spacing of the traps causes the particles to continuously move along the array until reaching the last trap. Once particles are captured, they move continuously toward the end of the channel, where they are then held. The magnitude of the retention time at the end of the channel can be controlled by, for example, varying the potential well depth there. The velocity of a particle in the channel (Up) is not uniform, but directly proportional to the force through the particle mobility, (Up=F_{T}/6 πaπ), emphasizing that inertial effects are negligible at low Reynolds numbers. Because the capture cross-section and trapping force are both strongly dependent on particle size, precision diversion based on particle size is possible using this method.

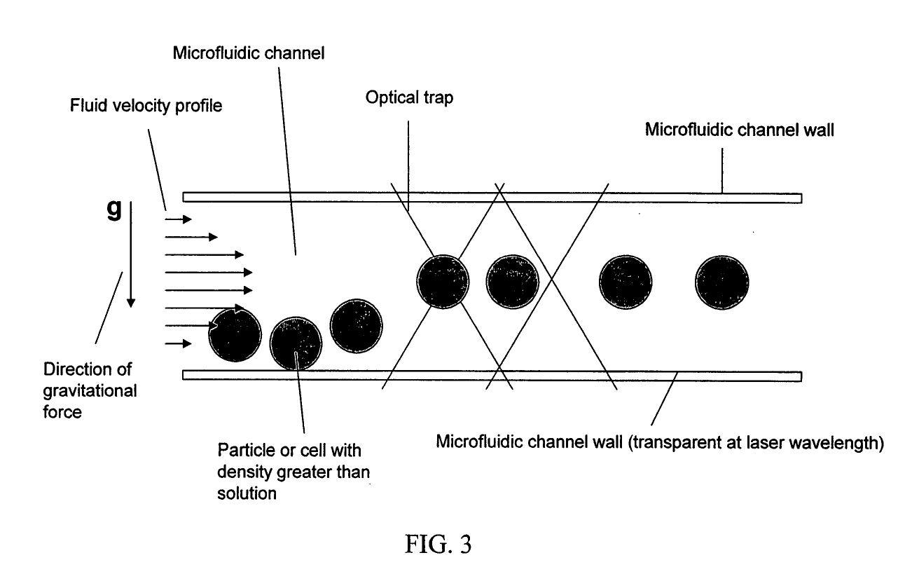

An example of an alternate embodiment of focusing geometry is shown in FIG. 3. Optical traps are used to direct particles or cells into the center of a channel, for example, by the gradient force or a combination of gradient and scattering and absorption forces. Similar to lateral focusing, this is done to offset the effects of sedimentation in channels and direct materials to faster streamlines, or to bring them into the focusing plane of a microscope or other analytical device.

An apparatus of the invention for separating particles and cells comprising a mircofluidic channel and an array of stationary optical traps positioned within the channel is useful in several applications. The microfluidic channel typically contains a solution of particles, with the solution flowing through the channel. The apparatus may, for example, have an array of optical traps that is a two-dimensional ordered array. Due to the physics of microfluidic flow, the arrays perform as though the channels are two-dimensional, without a depth dimension. The apparatus may alternatively, or in addition to the ordered array, include an array of optical traps in a two-dimensional cone-shaped focusing array. The benefits of the cone-shaped focusing array are discussed above.

The optical trap arrays of the invention may have optical traps positioned as close as necessary for optimum performance. Generally, spacing will be determined based on the order of the trapping laser wavelength, and, more specifically, the minimum spacing between two optical traps is determined based upon the diffraction limit of light used to generate the traps. It is preferred, however, that the spacing between the traps be limited by the beam waist of the focused laser generated by the traps. In other words, the spacing is preferably limited to the diameter of the focused laser beam. For instance, when using a wavelength between 488 nm and 1064 nm, a spacing of about 1 micron provides some overlap between traps. The strength of the trap is proportional to the difference in index of refraction between the particle and the surrounding solution. Additionally, trap strength is proportional to the shape of the particle, the size of the particle and laser intensity of the trap.

In using arrays of optical traps, the invention allows retaining or diverting particles in microfluidic flows as a function of their size, shape and optical properties. Similarly, particles can be dynamically diverted and manipulated using “optical channels” and arrangements of addressable static traps. This provides microfluidic systems providing analyte control independent of electrokinetic or pressure-driven fluid flows.

Modulation of Trap Strength

The optical trap arrays of the invention allow for separation characteristics to be altered in situ by turning optical traps on and off. This can be accomplished by using addressable optical attenuators. By turning the optical traps on and off, trap strength is controlled spatially or temporally. The spatial and temporal variation of trap strength is used to perform separations or manipulate analytes.

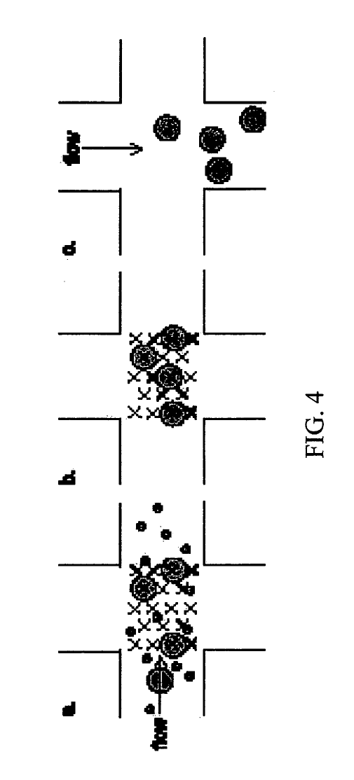

Turning traps on and off permits diverting particles into alternative routes in the microfluidic network. This type of operation is illustrated in FIGS. 4A, 4B, and 4C. The trap array shown in FIGS. 4A and 4B is positioned at the intersection of two channels. In this embodiment, small particles are separated from large particles by the traps, as illustrated in FIG. 4A, by retaining the large particles in the optical trap array, while the solution flow removes the smaller particles into the channel on the right. As shown in FIG. 4B, the large particles are separated from the small particles, and retained in the optical trap array. As shown in FIG. 4C, the optical traps are turned off, solution flow is directed from the top towards the bottom, and the large particles are directed into the channel below the intersection. Such a strategy provides separation of a few large particles from a much greater population of small particles, required for isolating aggregates formed in receptor-ligand binding assays.

Trap addressability for integrated devices provides greater flexibility for pulling individual particles through the channel by controlling their transport from one trap to the next. Trap addressability is advantageous when particles are used as vehicles for infinitesimal quantities of analyte, or for sampling particles from a microfluidic stream. For instance, when a particle is held in a trap, a neighboring trap will be activated, then the original turned off, allowing the particle to be pulled into the vacant trap. Such temporal or sequential “trapping” imparts a high degree of particle maneuverability throughout the device.

Applications

A method of separating particles flowing in a solution in a microfluidic channel has a variety of applications. The invention provides for separating particles with an index of refraction different from the index of refraction of the solution, by forming an optical trap located within the channel. The optical trap forms an interaction with the particles to be separated. To improve performance, a label unit may be attached to the particles intended to be diverted by the optical traps. By attaching a label unit, the size, shape and index of refraction can be altered to improve selectivity of the method.

Some examples of acceptable applications include solid-phase separation of particle aggregates that form in receptor-ligand interactions, enabling the detection, isolation and extraction of infinitesimal quantities of analyte from a sample. By mixing a first type of particle (such as a ligand) with a second type of particle (such as a receptor) in solution, a composite particle is formed. The composite particle may be separated out by forming an interaction with the optical trap and being diverted from the solution flow in a microfluidic device. Alternatively, the composite particle's progress through the channel could be delayed by its interaction with the trap, resulting in separation from other particles or materials in the flow. In addition, cell separation using optical traps allows capturing individual cell types from large, heterogeneous populations, an important possible application of “lab chips”.

Arrays and arrangements of static optical traps can be incorporated into rugged, integrated chip-based architectures. Use of optical traps eliminates complex microscale fabrications based on analogies to macro-scale devices, such as gears, cantilevers, and other objects used in the art because optical trap devices can take advantage of nanofabricated diffractive microlens arrays to create compact architectures.

Solid-Phase Separations and Immunological Assays

Static optical traps can be incorporated into a microfluidic device adapted to perform assays and solid-phase separations, an immunological assay being one specific example. For instance, optical traps can be used to separate out aggregates that form by interactions between antigens and antibodies. In prior art immunological assays, the aggregates must grow to a minimum diameter of at least 50 microns in order to be separated from non-interacting molecules. The optical traps of the present invention, however, can separate out much smaller aggregates, providing the capability to detect and manipulate infinitesimal quantities of antigen.

Agglutination assays are particle-based diagnostic tests that report the interaction of an antigen (Ag) with an antibody (Ab). Generally, sub-micron latex particles are used as a solid support, and act to magnify or amplify the Ag-Ab reaction through detectable aggregation of the particulate phase. Such assays have been applied successfully to diseases from a wide-range of pathogens, including bacterial, viral, fungal, mycoplasmal, protozoal and rickettsial. In order for agglutination assays to be effective, antigen must bind many particles such that aggregates create a visible change in turbidity or scattering. Because the present invention is sensitive to very small clusters, including even to doublets, it is able to detect antigens at minuscule concentrations. The smallest particle or aggregate size is governed by the physics of the optical trap, and depends on the refractive index, particle's shape, etc., as described above. For low dielectric particles typically used in conventional assays (i.e. silica, polystyrene or other polymer latex particles,) the minimum size that can be trapped is on the order of 100 nm, with the lifetime in the trap increasing significantly for particles or aggregates on the order of 1 micron for a laser wavelength of 1064 nm. However, metallic nanoparticles that are in the Rayleigh regime, such as 10 nm gold, can also be trapped due to their high dielectric constant.

For example, in current immunological assays, 100 nm diameter particles aggregate to form visible clusters, with a minimum diameter of approximately 50 μm. The number of particles in an aggregate of diameter dₖ is given by k=(dₖ/d)^{d}^{_{f}}, where d is the particle diameter and d_{f} is the fractal dimension of the cluster, which ranges between d_{f}=1.8-2.2 for diffusion-limited and reaction-limited aggregation, respectively. Thus, a visible cluster contains roughly 10⁵ particles, requiring at a minimum 10⁵-10⁶ antigen molecules to interact. The amount of antigen detectable in one hundred clumps, assuming a molecular weight MW=150,000 (≈MW of IgG), would be 25 picograms, highlighting the sensitivity of current assays. The present invention, on the other hand, can be used to capture aggregates as small as one-micron in size selectively, each containing as few as approximately 100 particles. Formation of 100 such aggregates in a microfluidic channel results in a thousand-fold reduction in the detectable antigen mass, down to approximately 25 femptograms. Depending on the sensitivity of the trapping separation employed, only a handful of aggregates may be needed, allowing regimes where atogram (10⁻¹⁸ g) quantities of antigen could be detected and manipulated.

The tests discussed above provide diagnostic (positive or negative) results for the presence of an antigen. The selectivity of the present invention's trap-based separations on particle size allow for measuring the size of the aggregate to determine analyte concentration in a manner similar to light-scattering immunoassays. Again, the present invention provides a signal from fewer aggregates, and thus, a much lower quantity of analyte is necessary.

Other applications of solid-phase separation include the purification of sequencing reaction products, PCR products, M13 phase, lambda phage, plasmids, cosmids and bacterial artificial chromosomes (BACs), among others. Particles are often used to capture target sequences, including the use of oligo-modified microspheres to capture mRNA and oligonucleotide-modified particles to capture double stranded DNA. After capture by microspheres, optical traps enable fast isolation and separation to downstream processes

Cell Sorting

In addition to the solid-phase separations capabilities described above, the present invention can also be used in cell sorting and cell separations. Cell sorting and separations are likely to be a major operation in micro total analytical systems, particularly for obtaining rare cell types from blood samples, such as hematopoietic stem cells, residual tumor cells, and antigen-specific B- and T-cells. The present invention allows for collection or analysis of rare cells using downstream single-cell sequencers.

Cell separations may be performed by the present invention similarly to the methods described above for particle separations. Specifically, by establishing the physical forces that govern maximum trapping force, selectivity, residence time and effect of collisions for cells, different cell types can be separated. For example, differentiation by size can be a first step for separating the three major blood cells, erythrocytes, leukocytes and platelets, as well as rare and pathogenic cells. The selectivity, long retention times and implementation of real-time control offered by the present invention, enable the detection, capture and analysis of rare cells in a compact, portable device using the present invention. Optical trap arrays may also prove to be useful for separating individual organelles after cells are lysed.

Another application of optical trap arrays of the present invention is to dynamically pattern cells in microfluidic channels and devices. Placing cells at specific locations, such as channel junctions, is an important function of miniaturized cell-based chemical and biological sensors. The optical traps of the present invention allow not only precise placement in a channel, but also the option of holding cells stationary for the duration of an analytical process, then releasing the cells to a waste stream, enabling repeated sampling. Additionally, cells can be held for treatment by another stream to introduce drugs, toxins, or other solutes, reducing the need for complex mixing operations necessitated by the creeping flow.

Multifunctional Separation Processes

The present invention also provides for separation operations that are easily incorporated into rugged, integrated chip-based micro total analytical architectures (also referred to throughout this document as “integrated architecture” and “MicroTAS”). To date, only a handful of completely integrated chemical systems have been demonstrated in the art. The lack of integrated chemical systems stems primarily from the many complex microscale fabrications that are required when forming devices based on macro-scale systems. Such devices require microscale analogies to components such as gears, cantilevers, and pumps.

The integrated architecture devices of the present invention based on optical-trap separations, however, do not require the microscale fabrication of such macroscale devices. Instead, the present optical trap devices make use of nanofabricated diffractive microlenses and the physics of microscale dynamics.

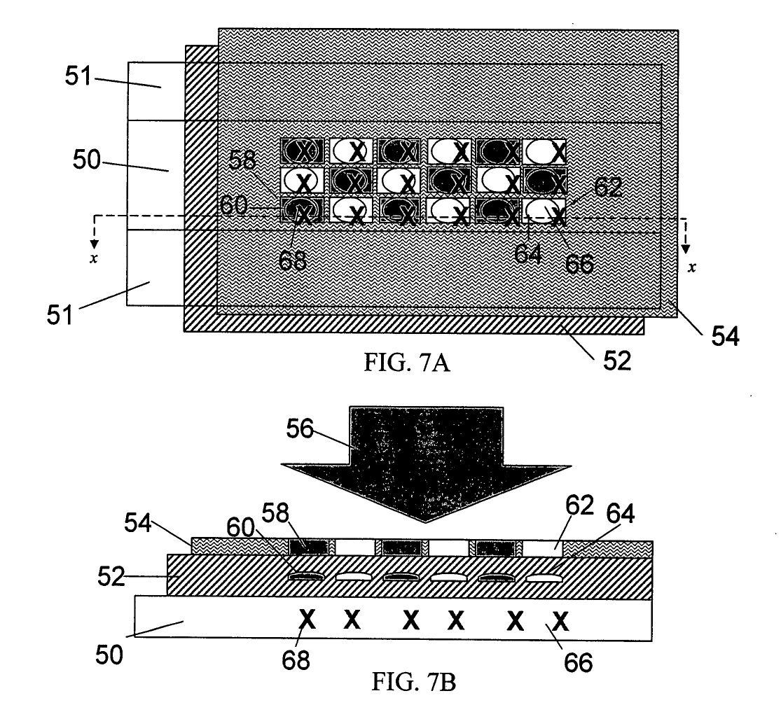

An exemplary chip-based separation device is illustrated in FIGS. 7A and 7B. A microfluidic device comprising a channel 50 with channel walls 51 is shown. A lenslet array layer 52 and an addressable attenuator layer 54 are shown over the microfluidic channel. The lenslet array layer contains an array of lenses 60 and 64 that are used in conjunction with the addressable attenuator layer 54. The addressable attenuator layer comprises an array of addressable attenuators 58 and 62, which control the attenuation of light supplied by a light source 56, such as a laser.

When an attenuator 58 is activated to supply light to the corresponding lens 60, an optical trap 68 is established at the corresponding position in the microfluidic channel. Alternatively, when an attenuator 62 is not activated, no light is supplied to the corresponding lens 64 and there is no optical trap generated at the corresponding position in the microfluidic channel 66.

Compact, integrated microfluidic systems as described in this invention can easily incorporate addressable arrays of optical traps using nanofabricated diffractive lenslets and liquid crystal attenuators. Trap spacing may be slightly larger than the particle size, but more complex diffractive elements can be used to reduce the distance between traps. The spacing of the optical traps is limited only by the wavelength of light used to generate the trap.

Static trap arrays generated with lenslets can be incorporated easily throughout the microfluidic device. Liquid crystalline matrices may be used to attenuate the laser beam at individual lenses, providing control of traps and trap strength. In addition to enabling separations, such strategies for control and movement may contribute to the formation of compact, integrated particle-based microfluidic pumps and valves, or cell positioning for assays and sensor applications.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

### Example 1

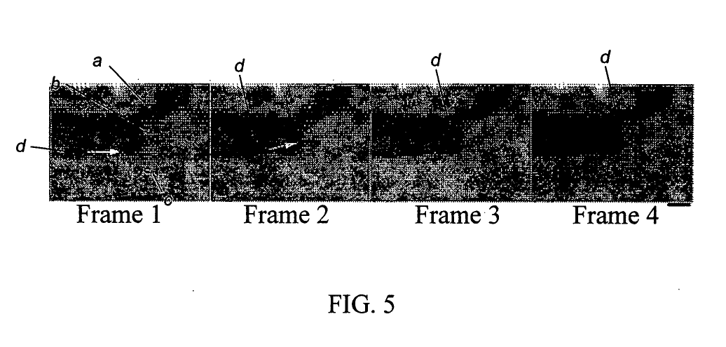

FIG. 5 shows a series of frames of photographs of static optical traps manipulating particles in a mircofluidic channel. In each of the frames, there is a linear array of seven optical traps (not shown) operating in a time-shared fashion. The linear array of time-shared optical traps is aligned perpendicular to the channel flow.

The sequence of video frames shows three particles (a, b and c) held stationary in the flow, which is moving from left to right at 140 μm/s. A fourth particle (d), slightly out of the focal plane, moves along a fluid streamline until it is captured by a trap. The scale bar is 10 μm. The residence times of particles under these conditions are on the order of minutes.

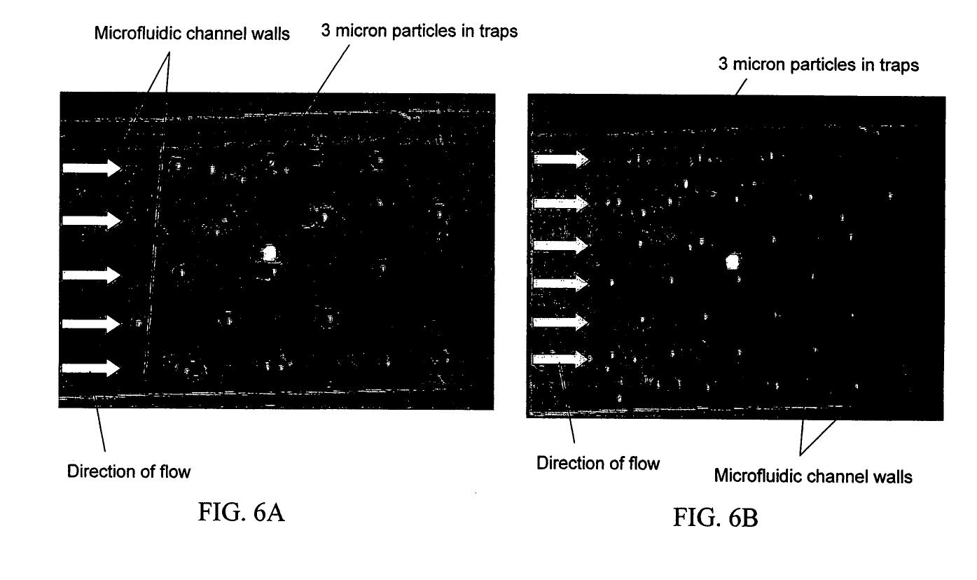

FIGS. 6A and 6B show photographs of two-dimensional hexagonal arrays with different trap spacings and a different number of traps. The 3 micron polystyrene particles are being held against the flow in the channel. For example, FIG. 6A shows a 5×5 hexagonal array filled with 3 μm polystyrene particles at a volume fraction of about 3%. The laser power is set to about 2.5 Watts and the flow rate is set to about 0.02 mL/hr. FIG. 6B shows a 7×8 hexagonal array filled with 3 μm polystyrene particles at a volume fraction of about 3%. The laser power is set to about 2.5 Watts and the flow rate is set to about 0.01 mL/hr.

### Example 2

Using static trap arrays, particles are selectively retarded or captured based on size. In a model separation, 1 micron and 3 micron polystyrene particles were separated. A 9×2 array of traps with a total laser power of 384 mW (21 mW per trap) was used in the model separation experiment. The fluid velocity was 18 μm/s, yielding a drag force of 0.4 pN on the 1 micron particles, and 1 pN on the 3 micron particles. The results of the separation experiment are shown in Table 1.

TABLE 1

| Particle size | Drag force | Residence | | Trapped |
|---|---|---|---|---|
| (μm) | (pN) | time (s) | Total particles | particles |
| 1 | 0.35 | <0.5 | 22 | 0 (0%) |
| 3 | 1.0 | >tₑₓₚ | 14 | 10 (71%) |

In this separation example, the 3 micron particles were trapped and held with a residence time longer than the time of the experiment, however, none of the 1 micron particles were held by the traps. The 1 micron particles had a residence time of less than a second and hopped through the two traps. Ten out of 14 of the 3 micron particles were trapped and held until the end of the separation, yielding 71% retention of the 3 micron particles. The four particles that were lost were primarily knocked out of the traps by incoming 3 micron particles.

In this separation example, 1 micron particles did not displace 3 micron particles from the traps. The selectivity of the separation S_{A} was defined as the number of particles of size A (N_{A}) that were trapped divided by the total number of trapped particles (N_{A}+N_{B}). This relationship is expressed in Eqn. 1
S_{A}=N_{A}/(N_{A}+N_{B}) (Eqn. 1)

The selectivity can range from 0 (no particles of size A recovered) to 1 (only particles of size A are recovered). A similar selectivity can be defined for the particles that passed through the traps. The selectivity of the separation was 1 for the 3 micron particles in the traps, meaning only 3 micron particles were retained in the traps. The selectivity for 1 micron particles in the downstream fraction was 0.85, meaning that in the downstream effluent, 85% of the particles were 1 micron particles.

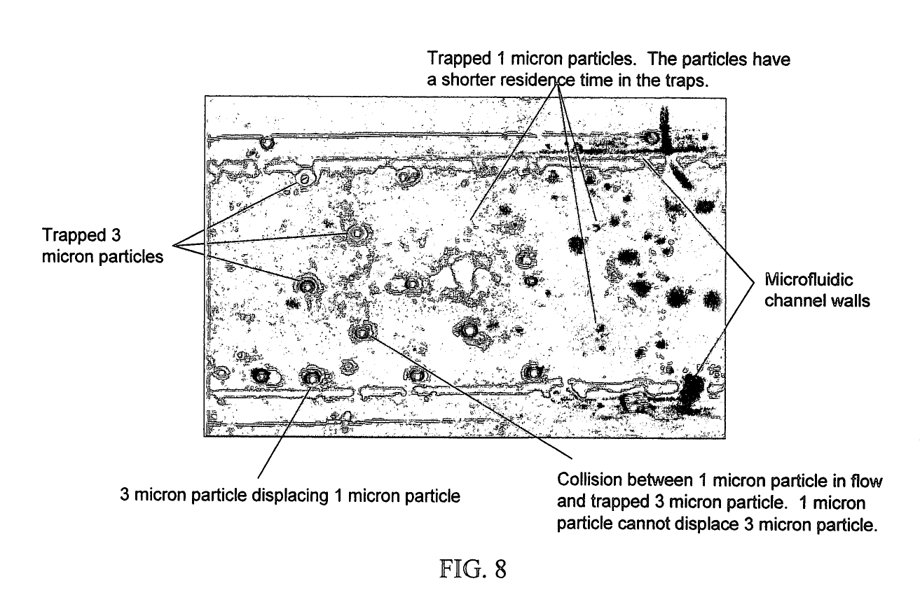

FIG. 8 shows a photograph of a 6×6 hexagonal array filled with both 1 μm and 3 μm polystyrene particles at a volume fraction of about 1% and 1%, respectively. The laser power is set to about 1.5 Watts and the flow rate is set to about 0.01 mL/hr. The figure demonstrates the feasibility for selectively retarding larger particles over smaller particles. Both particles are trapped and held stationary against the flow; however the 1 micron particles can be displaced by 3 micron particles entering the trap, while the 1 micron particles cannot displace 3 micron particles.

What is claimed:

1. A method for retaining, slowing or diverting particles comprising the steps of:
A. providing at least one microfluidic flow comprising a solution and at least one particle, said microfluidic flow disposed in a channel; and
B. providing at least one array of static optical traps positioned within the channel, said static optical traps adapted to retain, slow or divert said particle.

2. The method of claim 1 wherein said array is designed to retain, slow or divert the particle based on said particle's size, shape, optical properties or combination thereof.

3. The method of claim 1 wherein said array comprises at least one focusing array.

4. The method of claim 3 wherein said focusing array comprises a cone-shaped focusing array.

5. The method of claim 1 wherein said array comprises at least one two-dimensional ordered array.

6. The method of claim 1 wherein said array comprises at least one optical channel.

7. The method of claim 1 further comprising a minimum space between each optical trap wherein the minimum space is defined by the diffraction limit of light used to generate each of said traps.

8. The method of claim 1 wherein each of said traps comprises an effective trap force, wherein said effective trap force is proportional to said particle's shape.

9. The method of claim 1 wherein each of said traps has a strength and said trap strength is proportional to said particle's shape, said particle's size, intensity of said optical trap and to the difference in index of refraction between said particle and said solution.

10. The method of claim 1 wherein said trap strength is controlled spatially or temporally.

11. The method of claim 1 wherein one or more of said optical traps is adapted to be activated and inactivated.

12. The method of claim 1 wherein said array of optical traps comprises nanofabricated diffractive lenslets and attenuators.

13. A method for separating particles comprising the steps of:
A. providing at least one microfluidic flow comprising a solution and a plurality of particles, said microfluidic flow disposed in a channel;
and
B. providing at least one array of static optical traps positioned within the channel, said optical traps adapted to retain, slow or divert said particles.

14. The method of claim 13 wherein said array is designed to separate the particles based on said particles' size, shape, optical properties or combination thereof.

15. The method of claim 13 wherein said array comprises at least one focusing array.

16. The method of claim 15 wherein said focusing array comprises a cone-shaped focusing array.

17. The method of claim 13 wherein said array comprises at least one two-dimensional ordered array.

18. The method of claim 13 wherein said array comprises at least one optical channel.

19. The method of claim 13 further comprising a minimum space between each optical trap wherein the minimum space is defined by the diffraction limit of light used to generate each of said traps.

20. The method of claim 13 wherein each of said traps comprises an effective trap force, wherein said effective trap force is proportional to said particle's shape.

21. The method of claim 13 wherein each of said traps has a strength and said trap strength is proportional to the difference in index of refraction between said particle and said solution.

22. The method of claim 13 wherein said trap strength is controlled spatially or temporally.

23. The method of claim 13 wherein one or more of said optical traps is adapted to be activated and inactivated.

24. The method of claim 13 wherein said array of optical traps comprises nanofabricated diffractive lenslets and attenuators.

25. An apparatus for separating particles comprising a channel, a microfluidic flow and an array of static optical traps.

26. The apparatus of claim 25 further comprising a micro total analytical system.

27. The apparatus of claim 26 wherein said array of optical traps comprises nanofabricated diffractive lenslets and attenuators.

28. The apparatus of claim 25 wherein said array is designed to separate the particles based on said particles' size, shape, optical properties or combination thereof.

29. The apparatus of claim 25 wherein said array comprises at least one focusing array.

30. The apparatus of claim 29 wherein said focusing array comprises a cone-shaped focusing array.

31. The apparatus of claim 25 wherein said array comprises at least one two-dimensional ordered array.

32. The apparatus of claim 25 wherein said array comprises at least one optical channel.

33. The apparatus of claim 25 further comprising a minimum space between each optical trap wherein the minimum space is defined by the diffraction limit of light used to generate each of said traps.

34. The apparatus of claim 25 wherein each of said traps comprises an effective trap force, wherein said effective trap force is proportional to said particle's shape.

35. The apparatus of claim 25 wherein each of said traps has a strength and said trap strength is proportional to the difference in index of refraction between said particle and said solution.

36. The apparatus of claim 25 wherein said trap strength is controlled spatially or temporally.

37. The apparatus of claim 25 wherein one or more of said optical traps is adapted to be activated and inactivated.

38. A method for selecting or analyzing one or more particles comprising the steps of:
A. providing at least one microfluidic flow comprising a solution and a plurality of particles, said microfluidic flow disposed in a channel;
B. providing at least one focusing array of static optical traps positioned within the channel, said focusing array; and
C. providing at least one analytical device in coordination with said focusing array whereby said analytical device is adapted to analyze individual particles located within the focusing array.

39. The method of claim 38 wherein said analytical device is selected from the group consisting of a spectrometer, a fluorimeter, a photometer, and a microscope.
